(19) United States
(12) Patent Application Publication
(10) Pub. No.: US 2024/0121674 A1
(43) Pub. Date: Apr. 11, 2024

(54) QUALITY OF EXPERIENCE INDICATION AND REPORTING IN MOBILITY MANAGEMENT

(71) Applicant: QUALCOMM Incorporated, San Diego, CA (US)

(72) Inventors: Yuwei REN, Beijing (CN); Peng CHENG, Beijing (CN); Hao XU, Beijing (CN); Yin HUANG, Beijing (CN)

(21) Appl. No.: 18/257,571

(22) PCT Filed: Mar. 3, 2021
(86) PCT No.: PCT/CN2021/078833

§ 371 Date: Jun. 14, 2023

(51) Int. Cl. H04W 36/00; H04W 36/08; H04W 36/30; H04W 36/32

(52) U.S. Cl. CPC H04W 36/0058; H04W 36/085; H04W 36/30; H04W 36/324

(57) ABSTRACT

Techniques to incorporate quality of experience (QoE) in mobility management are disclosed. A user equipment (UE) may provide a QoE report to network (e.g., cell) upon detection of a QoE report triggering event (e.g., mobility management, environmental trigger, etc.). The QoE report may comprise information related to QoE metrics such as uplink (UL) latency, UL throughput, UL error rate, downlink (DL) frequency, DL throughput, DL error rate, handover (HO) frequency, beam switch frequency, UE power consumption, etc. The network may take actions such as sending a mobility management command if it is decided that QoE should be restored to the UE.

### CROSS-REFERENCE TO RELATED APPLICATIONS

The present application for Patent is a national stage application, filed under 35 U.S.C. § 371, of International Patent Application No. PCT/CN2021/078833, entitled, “QUALITY OF EXPERIENCE INDICATION AND REPORTING IN MOBILITY MANAGEMENT”, filed Mar. 3, 2021, which is assigned to the assignee hereof and is expressly incorporated herein by reference in its entirety.

### TECHNICAL FIELD

Various aspects described herein generally relate to wireless communication systems, and more particularly, to quality of experience (QoE) indication and reporting in mobility management.

### BACKGROUND

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service and a fourth-generation (4G) service (e.g., Long-Term Evolution (LTE) or Worldwide Interoperability for Microwave Access (WiMAX)). There are presently many different types of wireless communication systems in use, including Cellular and Personal Communications Service (PCS) systems. Examples of known cellular systems include the cellular Analog Advanced Mobile Phone System (AMPS), and digital cellular systems based on Code Division Multiple Access (CDMA), Frequency Division Multiple Access (FDMA), Time Division Multiple Access (TDMA), the Global System for Mobile access (GSM) variation of TDMA, etc.

A fifth generation (5G) mobile standard calls for higher data transfer speeds, greater numbers of connections, and better coverage, among other improvements. The 5G standard, according to the Next Generation Mobile Networks Alliance, is designed to provide data rates of several tens of megabits per second to each of tens of thousands of users, with 1 gigabit per second to tens of workers on an office floor. Several hundreds of thousands of simultaneous connections should be supported in order to support large sensor deployments. Consequently, the spectral efficiency of 5G mobile communications should be significantly enhanced compared to the current 4G standard. Furthermore, signaling efficiencies should be enhanced and latency should be substantially reduced compared to current standards. Up until now, a target cell for connection of a user equipment (UE) has been selected based on signal strength or quality the target cell. However, exclusive focus on signal strength or quality may not provide the best user experience.

### SUMMARY

This summary identifies features of some example aspects, and is not an exclusive or exhaustive description of the disclosed subject matter. Whether features or aspects are included in, or omitted from this summary is not intended as indicative of relative importance of such features. Additional features and aspects are described, and will become apparent to persons skilled in the art upon reading the following detailed description and viewing the drawings that form a part thereof.

An exemplary user equipment (UE) is disclosed. The UE may comprise a processor, a memory, and a transceiver. The processor, the memory, and/or the transceiver may be configured to detect a quality of experience (QoE) report triggering event. The processor, the memory, and/or the transceiver may also be configured to provide a QoE report to a network when the QoE report triggering event is detected. The QoE report may comprise information related to one or more QoE metrics.

An exemplary method of a user equipment (UE) is disclosed. The method may comprise detecting a quality of experience (QoE) report triggering event. The method may also comprise providing a QoE report to a network when the QoE report triggering event is detected. The QoE report may comprise information related to one or more QoE metrics.

Another exemplary user equipment (UE) is disclosed. The UE may comprise means for detecting a quality of experience (QoE) report triggering event. The UE may also comprise means for providing a QoE report to a network when the QoE report triggering event is detected. The QoE report may comprise information related to one or more QoE metrics.

A non-transitory computer-readable medium storing computer-executable instructions for a user equipment (UE) is disclosed. The executable instructions may comprise one or more instructions instructing the UE to detect a quality of experience (QoE) report triggering event. The executable instructions may also comprise one or more instructions instructing the UE to provide a QoE report to a network when the QoE report triggering event is detected. The QoE report may comprise information related to one or more QoE metrics.

An exemplary cell of a network is disclosed. The cell may comprise a processor, a memory, and a transceiver. The processor, the memory, and/or the transceiver may be configured to receive a quality of experience (QoE) report from a user equipment (UE). The QoE report may comprise information related to one or more QoE metrics. The processor, the memory, and/or the transceiver may also be configured to send a mobility management command to the UE when it is determined, based on the QoE report, that at least one QoE metric is to be restored.

An exemplary method of a cell of a network is disclosed. The method may comprise receiving a quality of experience (QoE) report from a user equipment (UE). The QoE report may comprise information related to one or more QoE metrics. The method may also comprise sending a mobility management command to the UE when it is determined, based on the QoE report, that at least one QoE metric is to be restored.

Another exemplary cell of a network is disclosed. The UE may comprise means for receiving a quality of experience (QoE) report from a user equipment (UE). The QoE report may comprise information related to one or more QoE metrics. The UE may also comprise means for sending a mobility management command to the UE when it is determined, based on the QoE report, that at least one QoE metric is to be restored.

A non-transitory computer-readable medium storing computer-executable instructions for a cell of a network is disclosed. The executable instructions may comprise one or more instructions instructing the UE to receive a quality of experience (QoE) report from a user equipment (UE). The QoE report may comprise information related to one or more QoE metrics. The executable instructions may also comprise one or more instructions instructing the UE to send a mobility management command to the UE when it is determined, based on the QoE report, that at least one QoE metric is to be restored.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of examples of one or more aspects of the disclosed subject matter and are provided solely for illustration of the examples and not limitation thereof:

FIG. 1 illustrates an exemplary wireless communications system in accordance with one or more aspects of the disclosure;

FIG. 2 is a simplified block diagram of several sample aspects of components that may be employed in wireless communication nodes and configured to support communication in accordance with one or more aspects of the disclosure;

FIGS. 3-5 illustrate example issues arising out of conventional baseline or conditional handover scenarios;

FIGS. 6-7 illustrate examples of communication flows between a user equipment and a network to incorporate quality of experience in accordance with one or more aspects of the disclosure;

FIG. 8 illustrates a flow chart of an example method performed by a user equipment to incorporate quality of experience in accordance with one or more aspects of the disclosure;

FIG. 9 illustrates a flow chart of an example method performed by a cell of a network to incorporate quality of experience in accordance with one or more aspects of the disclosure;

FIG. 10 illustrates a simplified block diagram of several sample aspects of a user equipment apparatus configured to incorporate quality of experience in accordance with one or more aspects of the disclosure;

FIG. 11 illustrates a simplified block diagram of several sample aspects of cell apparatus configured to incorporate quality of experience in accordance with one or more aspects of the disclosure;

FIG. 12 illustrates non-limiting examples of devices with cell selection devices integrated therein.

### DETAILED DESCRIPTION

Aspects of the subject matter are provided in the following description and related drawings directed to specific examples of the disclosed subject matter. Alternates may be devised without departing from the scope of the disclosed subject matter. Additionally, well-known elements will not be described in detail or will be omitted so as not to obscure the relevant details.

The word “exemplary” is used herein to mean “serving as an example, instance, or illustration.” Any aspect described herein as “exemplary” is not necessarily to be construed as preferred or advantageous over other aspects. Likewise, the term “aspects” does not require that all aspects include the discussed feature, advantage, or mode of operation.

The terminology used herein describes particular aspects only and should not be construed to limit any aspects disclosed herein. As used herein, the singular forms “a,” “an,” and “the” are intended to include the plural forms as well, unless the context clearly indicates otherwise. Those skilled in the art will further understand that the terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

Further, various aspects may be described in terms of sequences of actions to be performed by, for example, elements of a computing device. Those skilled in the art will recognize that various actions described herein can be performed by specific circuits (e.g., an application specific integrated circuit (ASIC)), by program instructions being executed by one or more processors, or by a combination of both. Additionally, these sequences of actions described herein can be considered to be embodied entirely within any form of non-transitory computer-readable medium having stored thereon a corresponding set of computer instructions that upon execution would cause an associated processor to perform the functionality described herein. Thus, the various aspects described herein may be embodied in a number of different forms, all of which have been contemplated to be within the scope of the claimed subject matter. In addition, for each of the aspects described herein, the corresponding form of any such aspects may be described herein as, for example, “logic configured to” and/or other structural components configured to perform the described action.

As used herein, terms “user equipment” (UE) and “base station” are not intended to be specific or otherwise limited to any particular Radio Access Technology (RAT), unless otherwise noted. In general, UEs may be any wireless communication device (e.g., mobile phone, router, tablet computer, laptop computer, consumer asset tracking device, Internet of Things (IoT) device, etc.) used by user to communicate over wireless communications network. UE may be mobile or may (e.g., at certain times) be stationary, and may communicate with Radio Access Network (RAN). As used herein, “UE” may be referred to interchangeably as “access terminal” or “AT,” “client device,” “wireless device,” “subscriber device,” “subscriber terminal,” “subscriber station,” “user terminal” UT, “mobile terminal,” “mobile station,” or variations thereof. Generally, UEs can communicate with core network via RAN, and through the core network the UEs can be connected with external networks such as Internet and with other UEs. Of course, other mechanisms of connecting to core network and/or the Internet are also possible for UEs, such as over wired access networks, WiFi networks (e.g., based on Institute of Electrical and Electronics Engineers (IEEE) 802.11, etc.) and so on.

A base station may operate according to one of several RATs in communication with UEs depending on the network in which it is deployed, and may be alternatively referred to as Access Point (AP), Network Node, NodeB, evolved NodeB (eNB, eNodeB), general Node B (gNB, gNodeB), etc. In addition, in some systems base station may provide edge node signaling functions, while in other systems it may provide additional control and/or network management functions.

UEs can be embodied by any of a number of device types including but not limited to printed circuit (PC) cards, compact flash devices, external or internal modems, wireless or wireline phones, smartphones, tablets, consumer asset tracking devices, asset tags, and so on. Communication link through which UEs can send signals to RAN may be referred to as uplink (UL) channel (e.g., reverse traffic channel, reverse control channel, access channel, etc.). Communication link through which RAN can send signals to UEs may be referred to as downlink (DL) or forward link channel (e.g., paging channel, control channel, broadcast channel, forward traffic channel, etc.). As used herein, term traffic channel (TCH) can refer to either a UL/reverse or DL/forward traffic channel.

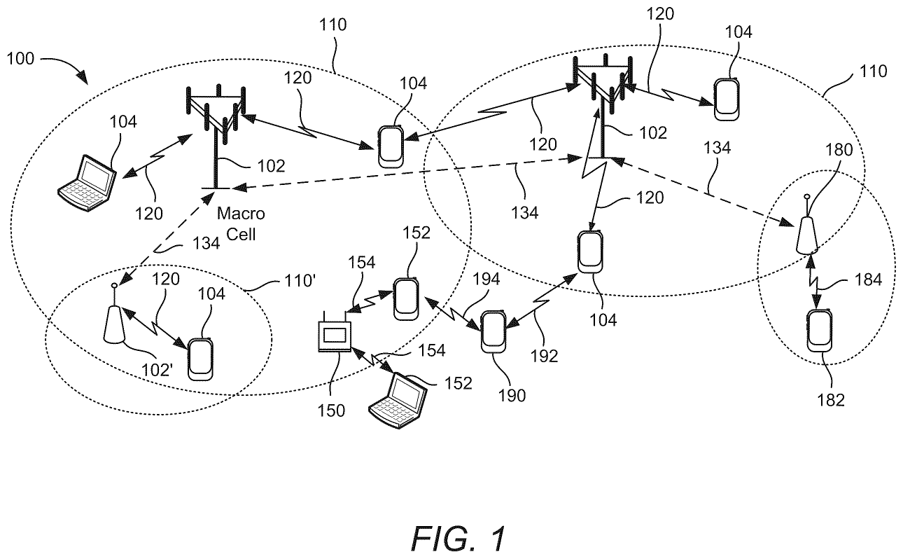

FIG. 1 illustrates an exemplary wireless communications system 100 according to one or more aspects. The wireless communications system 100, which may also be referred to as a wireless wide area network (WWAN), may include various base stations 102 and various UEs 104. The base stations 102 may include macro cells (high power cellular base stations) and/or small cells (low power cellular base stations). The macro cells may include Evolved NodeBs (eNBs) where the wireless communications system 100 corresponds to a Long-Term Evolution (LTE) network, gNodeBs (gNBs) where the wireless communications system 100 corresponds to a 5G network, and/or a combination thereof, and the small cells may include femtocells, picocells, microcells, etc.

The base stations 102 may collectively form a Radio Access Network (RAN) and interface with an Evolved Packet Core (EPC) or Next Generation Core (NGC) through backhaul links. In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC/NGC) over backhaul links 134, which may be wired or wireless.

The base stations 102 may wirelessly communicate with the UEs 104. Each of the base stations 102 may provide communication coverage for a respective geographic coverage area 110. In an aspect, although not shown in FIG. 1, coverage areas 110 may be subdivided into a plurality of cells (e.g., three), or sectors, each cell corresponding to a single antenna or array of antennas of a base station 102. As used herein, the term “cell” or “sector” may correspond to one of a plurality of cells of a base station 102, or to the base station 102 itself, depending on the context.

While neighbor macro cell geographic coverage areas 110 may partially overlap (e.g., in a handover region), some of the geographic coverage areas 110 may be substantially overlapped by a larger geographic coverage area 110. For example, a small cell base station 102′ may have a coverage area 110′ that substantially overlaps with the coverage area 110 of one or more macro cell base stations 102. A network that includes both small cell and macro cells may be known as a heterogeneous network. A heterogeneous network may also include Home eNBs (HeNBs) and/or Home gNBs (HgNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple input multiple output (MIMO) antenna technology, including spatial multiplexing, beamforming, and/or transmit diversity. The communication links may be through one or more carriers. Allocation of carriers may be asymmetric with respect to DL and UL (e.g., more or less carriers may be allocated for DL than for UL).

The wireless communications system 100 may further include a wireless local area network (WLAN) access point (AP) 150 in communication with WLAN stations (STAs) 152 via communication links 154 in an unlicensed frequency spectrum (e.g., 5 GHz). When communicating in an unlicensed frequency spectrum, the WLAN STAs 152 and/or the WLAN AP 150 may perform a clear channel assessment (CCA) prior to communicating in order to determine whether the channel is available.

The small cell base station 102′ may operate in a licensed and/or an unlicensed frequency spectrum. When operating in an unlicensed frequency spectrum, the small cell base station 102′ may employ LTE or 5G technology and use the same 5 GHz unlicensed frequency spectrum as used by the WLAN AP 150. The small cell base station 102′, employing LTE/5G in an unlicensed frequency spectrum, may boost coverage to and/or increase capacity of the access network. LTE in an unlicensed spectrum may be referred to as LTE-unlicensed (LTE-U), licensed assisted access (LAA), or MulteFire.

The wireless communications system 100 may further include a millimeter wave (mmW) base station 180 that may operate in mmW frequencies and/or near mmW frequencies in communication with a UE 182. Extremely high frequency (EHF) is part of the radio frequency (RF) range in the electromagnetic spectrum. EHF has a range of 30 GHz to 300 GHz and a wavelength between 1 and 10 mm. Radio waves in this band may be referred to as a millimeter wave. Near mmW may extend down to a frequency of 3 GHz with a wavelength of 100 mm. The super high frequency (SHF) band extends between 3 GHz and 30 GHz, also referred to as centimeter wave. Communications using the mmW/near mmW radio frequency band have high path loss and a relatively short range. The mmW base station 180 may utilize beamforming 184 with the UE 182 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

The wireless communications system 100 may further include one or more UEs, such as UE 190, that connects indirectly to one or more communication networks via one or more device-to-device (D2D) peer-to-peer (P2P) links. In the embodiment of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192-194 may be supported with any well-known D2D radio access technology (RAT), such as LTE Direct (LTE-D), WiFi Direct (WiFi-D), Bluetooth, and so on. Any of the base stations 102, 102′, 180 may send measurement requests (e.g., measurement control order (MCO)) to the UEs 104, 182, 190, and the UE's 104, 182, 190 may respond with measurement reports accordingly.

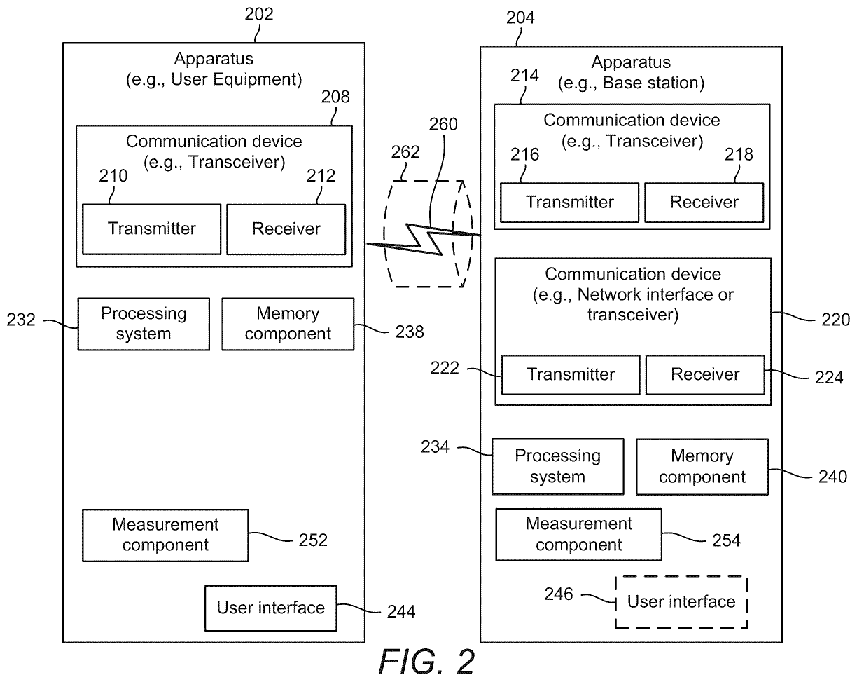

FIG. 2 illustrates several sample components (represented by corresponding blocks) that may be incorporated into an apparatus 202 and an apparatus 204 (corresponding to, for example, a UE and a base station (e.g., eNB, gNB), respectively, to support the operations as disclosed herein. As an example, the apparatus 202 may correspond to a UE, and the apparatus 204 may correspond to a network node such as a gNB and/or an eNB. It will be appreciated that the components may be implemented in different types of apparatuses in different implementations (e.g., in an ASIC, in a System-on-Chip (SoC), etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

The apparatus 202 may include at least one wireless communication device (represented by the communication device 208) for communicating with other nodes via at least one designated RAT (e.g., LTE, NR, etc.). The communication device 208 may include at least one transmitter (represented by the transmitter 210) for transmitting and encoding signals (e.g., messages, indications, information, and so on) and at least one receiver (represented by the receiver 212) for receiving and decoding signals (e.g., messages, indications, information, pilots, and so on).

The apparatus 204 may include at least one wireless communication device (represented by the communication device 214) for communicating with other nodes via at least one designated RAT (e.g., LTE, NR, etc.). The communication device 214 may include at least one transmitter (represented by the transmitter 216) for transmitting signals (e.g., messages, indications, information, pilots, and so on) and at least one receiver (represented by the receiver 218) for receiving signals (e.g., messages, indications, information, and so on).

For one or both apparatuses 202, 204, a transmitter and a receiver may comprise an integrated device (e.g., embodied as a transmitter circuit and a receiver circuit of a single communication device) in some implementations, may comprise a separate transmitter device and a separate receiver device in some other implementations, or may be embodied in other ways in yet other implementations. In an aspect, a transmitter may include a plurality of antennas, such as an antenna array, that permits the respective apparatus to perform transmit “beamforming,” as described further herein. Similarly, a receiver may include a plurality of antennas, such as an antenna array, that permits the respective apparatus to perform receive beamforming, as described further herein. In an aspect, the transmitter and receiver may share the same plurality of antennas, such that the respective apparatus can only receive or transmit at a given time, not both at the same time. A wireless communication device (e.g., one of multiple wireless communication devices) of the apparatus 204 may also comprise a Network Listen Module (NLM) or the like for performing various measurements.

The apparatus 204 may include at least one communication device (represented by the communication device 220) for communicating with other nodes. For example, the communication device 220 may comprise a network interface (e.g., one or more network access ports) configured to communicate with one or more network entities via a wire-based or wireless backhaul connection. In some aspects, the communication device 220 may be implemented as a transceiver configured to support wire-based or wireless signal communication. This communication may involve, for example, sending and receiving messages, parameters, or other types of information. Accordingly, in the example of FIG. 2, the communication device 220 is shown as comprising a transmitter 222 and a receiver 224 (e.g., network access ports for transmitting and receiving).

The apparatuses 202 and 204 may also include other components used in conjunction with the operations as disclosed herein. The apparatus 202 may include a processing system 232 for providing functionality relating to, for example, communication with the network. The apparatus 204 may include a processing system 234 for providing functionality relating to, for example, communication with the UEs. In an aspect, the processing systems 232 and 234 may include, for example, one or more general purpose processors, multi-core processors, ASICs, digital signal processors (DSPs), field programmable gate arrays (FPGA), or other programmable logic devices or processing circuitry.

The apparatuses 202 and 204 may include measurement components 252 and 254 that may be used to obtain channel related measurements. The measurement component 252 may measure one or more downlink (DL) signals such as channel state information reference signal (CSI-RS), phase tracking reference signal (PTRS), primary synchronization signal (PSS), secondary synchronization signal (SSS), demodulation reference signal (DMRS), etc. The measurement component 254 may measure one or more uplink (UL) signals such as DMRS, sounding reference signal (SRS), etc.

The apparatuses 202 and 204 may include memory components 238 and 240 (e.g., each including a memory device), respectively, for maintaining information (e.g., information indicative of reserved resources, thresholds, parameters, and so on). In various implementations, memory 238 can comprise a computer-readable medium storing one or more computer-executable instructions for a user equipment (UE) where the one or more instructions instruct apparatus 202 (e.g., processing system 232 in combination with communications device 208 and/or other aspects of apparatus 202) to perform any of the functions discussed herein. In addition, the apparatuses 202 and 204 may include user interface devices 244 and 246, respectively, for providing indications (e.g., audible and/or visual indications) to a user and/or for receiving user input (e.g., upon user actuation of a sensing device such a keypad, a touch screen, a microphone, and so on).

For convenience, the apparatuses 202 and 204 are shown in FIG. 2 as including various components that may be configured according to the various examples described herein. It will be appreciated, however, that the illustrated blocks may have different functionality in different designs. The components of FIG. 2 may be implemented in various ways. In some implementations, the components of FIG. 2 may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 208, 232, 238, and 244 may be implemented by processor and memory component(s) of the apparatus 202 (e.g., by execution of appropriate code and/or by appropriate configuration of processor components). Similarly, some or all of the functionality represented by blocks 214, 220, 234, 240, and 246 may be implemented by processor and memory component(s) of the apparatus 204 (e.g., by execution of appropriate code and/or by appropriate configuration of processor components).

In an aspect, the apparatus 204 may correspond to a “small cell” or a Home gNodeB. The apparatus 202 may transmit and receive messages via a wireless link 260 with the apparatus 204, the messages including information related to various types of communication (e.g., voice, data, multimedia services, associated control signaling, etc.). The wireless link 260 may operate over a communication medium of interest, shown by way of example in FIG. 2 as the medium 262, which may be shared with other communications as well as other RATs. A medium of this type may be composed of one or more frequency, time, and/or space communication resources (e.g., encompassing one or more channels across one or more carriers) associated with communication between one or more transmitter/receiver pairs, such as the apparatus 204 and the apparatus 202 for the medium 262.

In general, the apparatus 202 and the apparatus 204 may operate via the wireless link 260 according to one or more radio access types, such as LTE, LTE-U, or NR, depending on the network in which they are deployed. These networks may include, for example, different variants of CDMA networks (e.g., LTE networks, NR networks, etc.), TDMA networks, FDMA networks, Orthogonal FDMA (OFDMA) networks, Single-Carrier FDMA (SC-FDMA) networks, and so on.

A UE may be capable of operating in multiple radio access technologies (RATs). For example, a UE may be capable of operating in a first RAT (e.g., LTE) and in a second RAT (e.g., NR). These are merely examples, and first and second RATs may be any of the RATs currently known (e.g., WiMax, CDMA, Wideband CDMA (WCDMA), Universal Terrestrial Radio Access (UTRA), Evolved UTRA (E-UTRA), GSM, FDMA, GSM, TDMA, etc.).

Also, a UE may be capable of operating in multiple RATs at the same time. For example, a UE that can operate in both LTE and NR simultaneously is an E-UTRA-NR Dual Connectivity (ENDC) capable UE. Note that ENDC is an example of Multi-RAT DC (MRDC) capability. In general, when an MRDC capable UE is operating in two RATs, it may be communicating with a base station (e.g., eNB) of a first RAT (e.g., LTE) and with a base station (e.g., gNB) of a second RAT (e.g., NR). When the UE operates in the first RAT, it may communicate with a network node (e.g., base station, eNB, etc.) of the first RAT. Similarly, when the UE operates in the second RAT, it may communicate with a network node (e.g., base station, gNB, etc.) of the second RAT.

Quality of experience (QoE) may be viewed as an attempt to embrace subjective experiences of a service user, with all their complexities and human dependent variables such as statistics, physical, temporal, and even social and economic factors. In communications, different metrics may be used to quantify QoE at the UE and at the network. QoE may include the following:
Latency, e.g, for small data packages;
Uplink (UL) throughput/file transmission time;
UL error rate (e.g., block error rate (BLER), bit error rate (BER), etc.);
Downlink (DL) throughput/file download time;
DL error rate;
Handover frequency;
Beam switch frequency;
UE power consumption. These are merely some examples and are not meant to be exhaustive.

There can be mobility challenges to manage for a UE in a network. For typical baseline handovers (HO) and conditional handovers (CHO), it is conventional that a cell with the strongest or best signal—e.g., highest reference signal received power (RSRP) or reference signal received quality (RSRQ)—be chosen as the target cell. Currently, the UE measures signals among cells to determine their RSRP or RSRQ, and the target cell is selected based on the signal measurements. However, this may not directly reflect the UE experience.

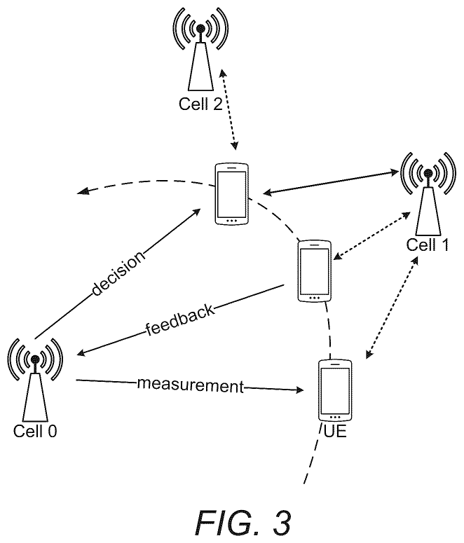

One issue is that there can be inaccuracies due to out-of-date measurement. Such a scenario is illustrated in FIG. 3 in which a UE is moving along the dashed curve. In this scenario, the UE is currently being served by cell 0, and takes measurements for potential handover, e.g., of neighbor cells 1 and 2. Based on current measurement, cell 1 is chosen as the target. However, for a very highly mobile UE, the connection can be short-term. At the time the HO action takes place, cell 1 is outdated and cell 2 is the optimum choice. Such an out-of-date HO can lead to degradation of UE experience. Thus, an accurate prediction of HO measurement would be desirable.

Another issue is that even the state-of-the-art handover algorithm may not be able to select appropriate target cell for HO. Although a selected target cell may provide largest reception power (e.g., highest RSRP), this does not necessarily mean that good QoE, such as latency, power consumption, etc., would be provided by the selected cell. For example, a UE may access the network through cell with high signal quality. However, access may also come with a large latency. As an illustration, instance messages with small package scheduling usually require frequent UL transmission. Even though the resources may be sufficient and the signal quality is the best, large UL latency can degrade the UE experience.

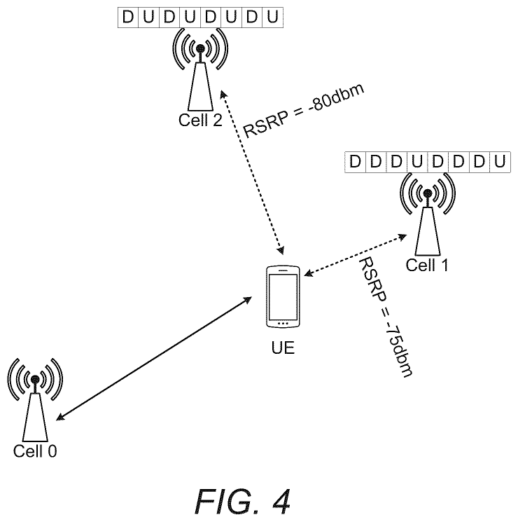

Such a scenario is illustrated in FIG. 4. Again, the UE is assumed to be currently connected to cell 0 and cells 1 and 2 are neighbor cells, one of which can be the next target cell. As seen, cell 1 is assumed to be better choice due to stronger signal (e.g., RSRP of −75 dbm for cell 1, RSRP of −80 dbm for cell 2). However, also as seen, cell 1 is configured with low density UL slots, while cell 2 is configured with high density UL slots (more uplink slots in cell 2 than in cell 1). Based on conventional selection algorithm, cell 1 would be selected as the target cell for handover. However, if the UE is instant messaging and texting, the UL latency would be longer if cell 1 is selected. Thus, for the UE handover in consideration of latency concerns, cell 2 may be a more optimal choice.

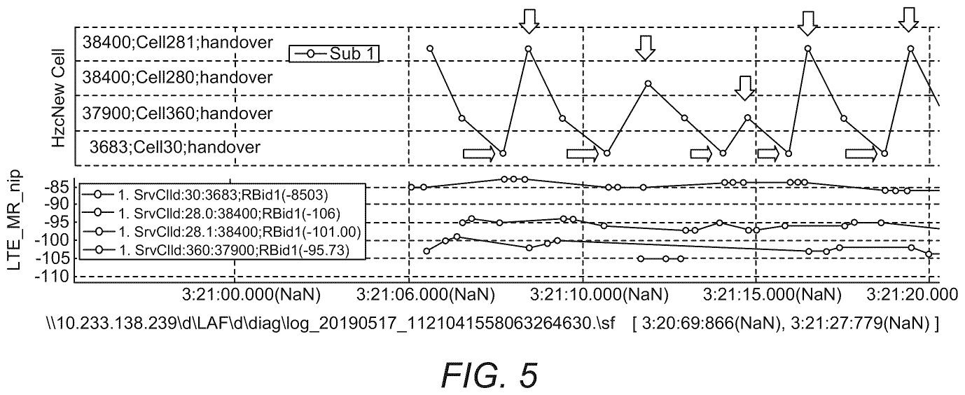

Another issue is illustrated in FIG. 5. A misconfiguration of event A4 can lead to HO ping pong. In Third Generation Partnership Project (3GPP), event A4 is defined as an event when neighbor cell measurement becomes better than a threshold. In FIG. 5, handovers occurring among multiple cells—280, 281, 360, 30—are shown. As seen, the signal strength from cell 30 is the highest. Cell 30 may represent a narrowband (NB) cell with high power located outdoors while other cells 280, 281, 360 may represent a wideband (WB) cell located indoors such as malls. When possible, for load balancing purposes, the network may promote connections to be switched from NB to WB cell.

In FIG. 5, the white arrows show the handovers to cell 30 from other cells. However, if the user enters indoors where the WB cells are located, network may cause handover to take place of the UE from the NB cell to the WB cells. The black arrows represent such handovers. Here, handover ping pong may occur. That is the UE may be handed over to the NB cell 30 since the signal from the NB cell is the strongest. Then another may take place from the NB cell to the WB cell to manage the load. Then the cycles of ping pong handover may repeat as seen.

So as to summarize, currently, mobility management procedure is mainly based on signal power/quality. For example, target cell selection is based on RSRP/RSRQ. But such channel quality metrics do not fully represent the UE experience. As seen above with respect to FIGS. 3, 4 and 5, mobility management might reduce the QoE, even when the selected cell has the highest signal power or quality.

To address these and other issues associated with conventional mobility management, it is proposed to involve QoE metrics in mobility management. The QoE metrics may be considered in addition to consideration of the channel quality. In general, the UE may provide a QoE report to the network so that the network may take actions—if necessary or desired—to restore or enhance the QoE of the UE.

In an aspect, the UE may indicate QoE variation to the network when a mobility management event occurs. For example, after a handover or a beam switch, the UE may indicate whether its QoE has changed after the mobility management event. In another aspect, the UE may report its QoE status to the network if some conditions are met. For example, if the UE's battery is low, then the UE may report its QoE to the network. By incorporating QoE in addition to channel quality considerations, user experience through the UE may be enhanced in different scenarios, not purely based on channel conditions.

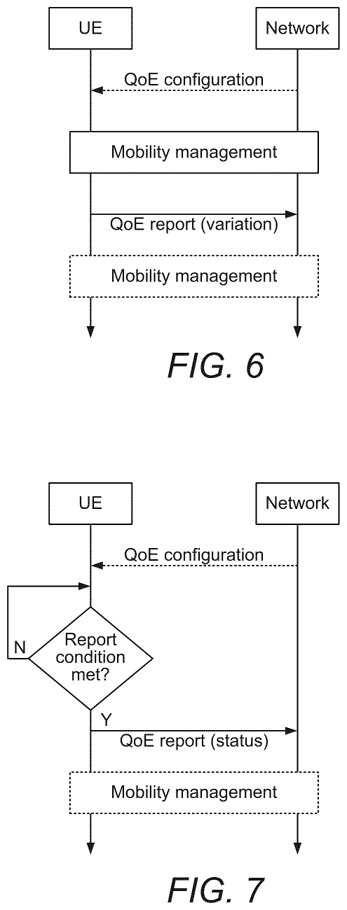

As mentioned above and as illustrated in FIG. 6, in an aspect, when a mobility management event occurs, the UE may indicate QoE variation to the network. As seen, the network initially may provide the UE with QoE configuration, e.g., through radio resource control (RRC) messages. For example, a cell of the network currently serving the UE—a current serving cell—may send the QoE configuration to the UE. The QoE configuration may include one or more QoE variation reporting rules.

In FIG. 6, the “QoE configuration” arrow is dashed to indicate that the network providing QoE configuration to the UE can be optional. Alternatively or in addition thereto, the UE may be configured with one or more native QoE configurations including one or more native QoE variation reporting rules. Such native QoE configuration may be preset within the UE (e.g., as a default or factory setting). In an aspect, if the QoE configuration includes a QoE variation reporting rule conflicts with a QoE variation reporting rule already in the UE (whether native or through a previous QoE configuration), the later reporting rule—the QoE variation reporting rule included in the QoE configuration—may take precedence.

When the UE detects that a mobility management event has occurred, the UE may send a QoE report indicating QoE variation. A mobility management event may be viewed as an event in which a communication channel changes between the UE and the network. A handover (HO) of a UE from one cell to another may be an example of the mobility management event. If the cell has multiple sectors, then a switch from one sector to another sector may also be considered to a form of HO for mobility management event purposes. A beam switch may be another example of the mobility management event.

As mentioned, when a mobility management event occurs, the UE may indicate one or more QoE variations to the network in the QoE report. In particular, the UE may report variations in one or more QoE metrics before and after the mobility management event. To state it another way, a change or changes in the QoE metrics from before the mobility management event to after the mobility management event may be reported in the QoE report in accordance with the QoE variation reporting rules (native and/or network configured) in effect. The QoE metrics may include any one or more of an uplink (UL) latency, a UL throughput, a UL error rate, a downlink (DL) latency, a DL throughput, a DL error rate, a handover (HO) frequency (how often HOs occur), a link failure frequency (how often link failures occurs), a beam switch frequency (e.g., how often beam switches occur), a UE power consumption, etc. The QoE report may be carried in one or more uplink control information (UCI) data.

In one aspect, the QoE report may comprise a QoE variation indicator comprising one bit. The value of the one bit QoE variation indicator may indicate whether at least one QoE metric has improved or not improved after the mobility management event. For example, a QoE variation reporting rule may specify that the UE is to report one of logical 1 or 0 if UL latency improves (e.g., becomes shorter) or to report other of logical 1 or 0 if UL latency does not improve (does not become shorter) after the mobility management event. In a different aspect, the QoE variation reporting rules may be associated with thresholds. For example, a QoE variation reporting rule may specify that the UE is to report one of logical 1 or 0 if UL latency improves by at least 5% or to report other of logical 1 or 0 if UL latency does not improve by at least 5% after the mobility management event.

Alternatively, instead of indicating whether there is an improvement or not, the one bit value of the QoE variation indicator may indicate whether at least one QoE metric has worsened or not worsened. For example, a QoE variation reporting rule may specify that the UE is to report one of logical 1 or 0 if DL throughput worsens or to report other of logical 1 or 0 if UL latency does not worsen after the mobility management event. Again, in a different aspect, thresholds may be associated. For example, a QoE variation reporting rule may specify that the UE is to report one of logical 1 or 0 if DL throughput worsens by more than 5% or to report other of logical 1 or 0 if UL latency does not worsen by more than 5% after the mobility management event.

Based on the QoE report, the network may determine whether or not the QoE of the UE should be restored. For example, it may be that the one bit value of QoE variation indicator indicates that the QoE has not improved (or has gotten worse). If such determination is made, then the network—through the serving cell—may send one or more mobility management commands (e.g., HO, beam switch, etc.) to the UE. For example, the network may command the UE to perform HO to the previous cell or to a new cell entirely. As another example, the network may command the UE to switch back to the previous beam, or to a new beam entirely. The one or more mobility management commands may be sent based on the QoE not improving (or getting worse) even if signal measurements (e.g., RSRP or RSRQ) improve compared to the previous cell or previous beam.

Sending the one bit QoE variation indicator minimizes the resources consumed in sending the QoE report. Alternatively, the QoE variation indicator may comprise multiple bits, and different bit values of the QoE variation indicator may correspond to variations in different QoE metrics after the mobility management event relative to prior to the mobility management event. For example, a first value may correspond to a variation in UL latency while a second value may correspond to a variation in UL throughput. It can also be that some different values of the QoE variation indicator may correspond to different variations in a same QoE metric. For example, a third value may correspond to a variation in DL throughput being between 10% and 25% while a fourth value may correspond to a variation in DL throughput being greater than 25%. For ease of reference, “QoE metric variation” may be used to refer to a variation—before and after the mobility management event—in a QoE metric.

It is recognized that in some instances, not all values of the multiple bit QoE variation indicator are valid. For example, in a three bit QoE variation indicator, it may be that only five values are valid (e.g., the other three values may be “reserved”). The QoE variation reporting rules may map the one or more valid QoE variation indicator values to the one or more QoE metric variations. The mapping may be maintained within the UE, e.g., in the memory of the UE. An example of such mappings is provided in Table 1 below.

TABLE 1

| QoE metric variation | QoE variation indicator value |
|---|---|
| No change or all changes within threshold | 0 |
| UL throughput decrease >50% | 1 |
| UL latency increase >100 ms | 2 |
| Link failure frequency decrease | 3 |
| . . . | . . . |

Again, based on the QoE report, the network may determine whether or not the QoE of the UE should be restored. For example, if the value of QoE variation indicator indicates that the QoE has not changed much, e.g., the changes of the QoE metrics are within their threshold (e.g., value “0” is returned), then the network may forego sending mobility management commands to the UE. On the other hand, if value “2” is returned to the network as the value of the QoE variation indicator, the network—through the serving cell—may send one or more mobility management commands (e.g., HO, beam switch, etc.) to the UE to improve the QoE potentially.

FIG. 7 illustrates another technique to incorporate QoE. In this aspect, the QoE report from the UE to the network may be triggered when a “QoE status event” occurs. The QoE status event may be viewed as being an event in which a status of at least one QoE metric exceeds a threshold corresponding that at least one QoE metric, also referred to as “QoE metric threshold” for convenience. For example, a UL latency threshold may be set at 50 ms. Then if the UL latency exceeds 50 ms, the QoE report may be triggered. As another example, a UL throughput threshold may be set at 1 Mbps. Then if the UL throughput is less than 1 Mps, the QoE report may be triggered.

Recall that the network may provide the UE with QoE configuration and/or the UE may have native QoE configurations. The QoE configurations may include one or more QoE status reporting rules. The QoE configurations may also include the QoE metric thresholds. Again, later configured QoS status reporting rule may take precedence over conflicting earlier configured (whether native or through previous QoE configuration) QoS status reporting rule.

In one aspect, the QoE report may comprise a QoE status indicator comprising one or more bits. Different values of the QoE status indicator may correspond to statuses of different QoE metrics. For example, a first value may correspond to the UL latency exceeding a UL latency threshold while a second value may correspond to the UL throughput being less than a UL throughput threshold. It can also be that multiple thresholds may be set for a QoE metric. Thus, at least two QoE status indicator values may correspond to two different statuses of a same QoE metric. For example, there may be three QoE metric thresholds for UL latency, e.g., first UL latency threshold at 50 ms, second UL latency threshold at 100 ms, and third UL latency threshold at 200 ms.

The QoE status reporting rules may map the one or more valid QoE status indicator values to the one or more QoE status events. The mapping may be maintained in the UE, e.g., in the UE's memory. An example of such mappings is provided in Table 2 below.

TABLE 2

| QoE status event | QoE variation indicator value |
|---|---|
| UL latency > 1000 ms | 0 |
| 1000 ms > UL latency > 100 ms | 1 |
| 100 ms > UL latency > 10 ms | 2 |
| UL throughput < 1 Mbps | 3 |
| 1 Mbps < UL throughput < 10 Mbps | 4 |
| . . . | . . . |

Based on the QoE report, the network may determine whether or not the QoE of the UE should be restored or otherwise improved. For example, it may be that the value of the QoE status indicator indicates that the corresponding QoE metric outside of established threshold for the QoE metric (e.g., UL latency is longer than 1000 ms). If such determination is made, then the network—through the serving cell—may send one or more mobility management commands (e.g., HO, beam switch, etc.) to the UE. For example, the network may command the UE to perform HO to another cell and/or a beam switch. As described above, the one or more mobility management commands may be sent based on the QoE not improving (or getting worse) regardless of whether signal measurements (e.g., RSRP or RSRQ) improve or do not improve.

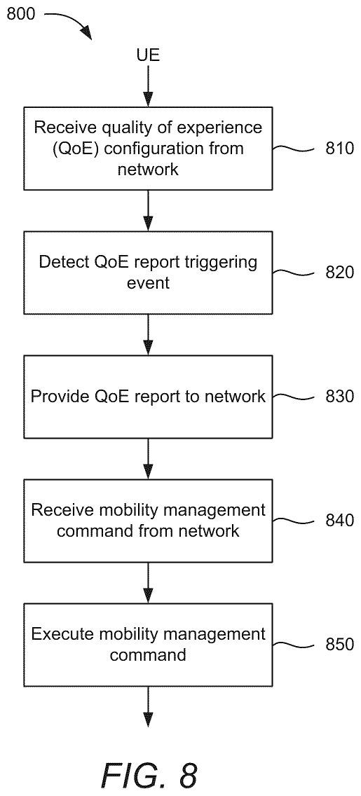

FIG. 8 illustrates a flow chart of an exemplary method 800 performed by a UE, e.g., to incorporate QoE in accordance with one or more aspects of the disclosure. Here, the UE (such as the apparatus 202) may be capable of operating in multiple radio access technologies (RATs) such as 5G NR and 4G LTE RATs among others. The memory component 238 may be viewed as an example of a non-transitory computer-readable medium that stores computer-executable instructions to operate components of the UE such as the communication device 208 (including transmitter 210 and receiver 212), the processing system 232 (including one or more processors), memory component 238, etc.

In block 810, the UE (e.g., processing system 232, memory component 238, communication device 208, etc.) may receive QoE configuration from the network, e.g., from a current serving cell of the network in an RRC message. The QoE configuration may include one or more QoE variation reporting rules and/or one or more QoE status reporting rules. As indicated above, the UE itself may be natively configured with QoE configuration. Thus, block 810 may be optional.

In block 820, the UE (e.g., processing system 232, memory component 238, communication device 208, measurement component 252, etc.) may detect a QoE report triggering event.

In block 830, the UE (e.g., processing system 232, memory component 238, communication device 208, etc.) may provide the QoE report to the network when the QoE report triggering event is detected. The QoE report may comprise information related to one or more QoE metrics. Examples of QoE metrics include an uplink (UL) latency, a UL throughput, a UL error rate, a downlink (DL) latency, a DL throughput, a DL error rate, a handover (HO) frequency, a link failure frequency, a beam switch frequency, and a UE power consumption.

In an aspect, the QoE report triggering event detected in block 820 may be a mobility management event as indicated above with respect to FIG. 6. Mobility management event may be viewed as an event in which a communication channel between the UE and the network changes. An example of mobility management event is a handover of the UE from a first cell to a second cell of the network. Another example of mobility management event is a beam switch from a first beam to a second beam.

Then the QoE report provided in block 830 may include a QoE variation indicator. In one aspect, the QoE variation indicator may comprise one bit. The bit value of the QoE variation indicator may indicate whether at least one QoE metric has or has not improved after the mobility management event. In a variation, the bit value of the QoE variation indicator may indicate whether at least one QoE metric has or has not improved by more than a threshold amount (e.g., 5%) after the mobility management event.

Alternatively, the bit value of the QoE variation indicator may indicate whether at least one QoE metric has or has not worsened after the mobility management event. In a variation, the bit value of the QoE variation indicator may indicate whether at least one QoE metric has or has not worsened by more than a threshold amount (e.g., 5%) after the mobility management event.

In another aspect, the QoE variation indicator may comprise multiple bits. A value of the QoE variation indicator, also referred to as a QoE variation indicator value, may correspond to a variation in one or more QoE metrics, also referred to as a QoE metric variation, after the mobility management event. The QoE variation indicator value may be one of one or more valid QoE variation indicator values. The one or more valid QoE variation indicator values may be mapped to the one or more QoE metric variations in accordance with one or more QoE variation reporting rules.

Some QoE variation indicator values may be mapped to different QoE metrics. That is, at least two QoE variation indicator values may correspond to reporting information of different QoE metrics. Alternatively or in combination therewith, some other QoE variation indicator values may be mapped to different variations of a same QoE metric.

Alternatively, in block 820, the QoE report triggering event detected in block 820 may be a QoE status management event as indicated above with respect to FIG. 7. QoE status event may be viewed as an event in which a status of at least one QoE metric exceeds a QoE metric threshold corresponding to the at least one QoE metric.

In this instance, the QoE report provided in block 830 may include a QoE status indicator. In one aspect, the QoE status indicator may comprise one or more bits. A value of the QoE status indicator, i.e, the QoE status indicator value, may correspond to a status of one or more QoE metrics. The QoE status indicator value may be one of one or more valid QoE status indicator values. The one or more valid QoE status indicator values may be mapped to the one or more QoE metric statuses in accordance with one or more QoE status reporting rules.

Some QoE status indicator values may be mapped to different QoE metrics. That is, at least two QoE status indicator values may correspond to reporting status information of different QoE metrics. Alternatively or in addition thereto, some other QoE variation indicator values may be mapped to different thresholds of a same QoE metric.

In block 840, the UE (e.g., processing system 232, memory component 238, communication device 208, etc.) may receive a mobility management command from the network, if the network deems it desirable. For example, the mobility management command may be a handover command (e.g., back to previous serving cell, to a whole new cell, etc.). In another example, the mobility management command may be a beam switch command (e.g., switch back to previous beam, switch to a different beam altogether, etc.).

In Block 850, the UE (e.g., processing system 232, memory component 238, communication device 208, etc.) may execute the received mobility management command.

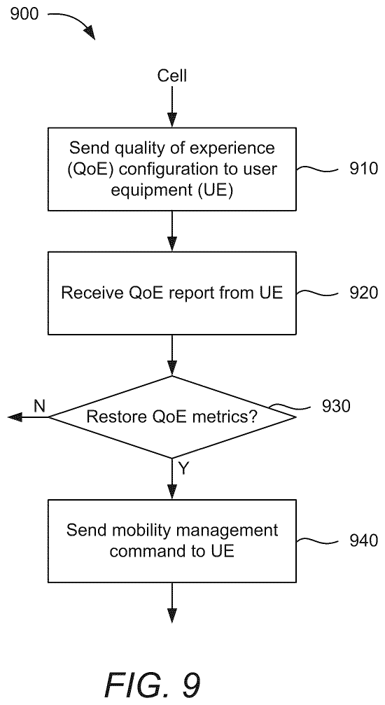

FIG. 9 illustrates a flow chart of an exemplary method 900 performed by a cell of a network to incorporate QoE in accordance with one or more aspects of the disclosure. Here, the cell (such as the apparatus 204) may be capable of operating in multiple radio access technologies (RATs) such as 5G NR and 4G LTE RATs among others. The memory component 240 may be viewed as an example of a non-transitory computer-readable medium that stores computer-executable instructions to operate components of the cell such as the communication device 214 (including transmitter 216 and receiver 218), the processing system 234 (including one or more processors), memory component 240, etc.

In block 910, the cell (e.g., processing system 234, memory component 240, communication device 214, etc.) may send QoE configuration to a UE, e.g., in an RRC message. The QoE configuration may include one or more QoE variation reporting rules and/or one or more QoE status reporting rules. As indicated above, the UE itself may be natively configured with QoE configuration. Thus, block 910 may be optional.

In block 920, the cell (e.g., processing system 232, memory component 238, communication device 208, etc.) may receive the QoE report from the UE. The QoE report may comprise information related to one or more QoE metrics. Again, examples of QoE metrics include an uplink (UL) latency, a UL throughput, a UL error rate, a downlink (DL) latency, a DL throughput, a DL error rate, a handover (HO) frequency, a link failure frequency, a beam switch frequency, and a UE power consumption.

In block 930, the cell (e.g., processing system 232, memory component 238, communication device 208, etc.) may determine whether at least one QoE metric is to be restored for the UE based on the received QoE report.

In block 940, the cell (e.g., processing system 232, memory component 238, communication device 208, etc.) may send a mobility management command to the UE when it is determined that the at least one QoE metric is to be restored. the mobility management command may be a handover command (e.g., back to previous serving cell, to a whole new cell, etc.). In another example, the mobility management command may be a beam switch command (e.g., switch back to previous beam, switch to a different beam altogether, etc.).

In an aspect, the QoE report received in block 920 may include a QoE variation indicator. In one aspect, the QoE variation indicator may comprise one bit. The bit value of the QoE variation indicator may indicate whether at least one QoE metric has or has not improved after a mobility management event. In this instance, in block 930, the cell may determine that the QoE of the UE is to be restored if the QoE variation indicator indicates that the QoE metric has not improved. In a variation, the cell may determine that the QoE of the UE is to be restored if the QoE variation indicator indicates that the QoE metric has not improved by more than a threshold amount (e.g., 5%).

Alternatively, the bit value of the QoE variation indicator received in block 920 may indicate whether at least one QoE metric has or has not worsened after the mobility management event. In this instance, in block 930, the cell may determine that the QoE of the UE is to be restored if the QoE variation indicator indicates that the QoE metric has worsened. In a variation, the cell may determine that the QoE of the UE is to be restored if the QoE variation indicator indicates that the QoE metric has worsened by more than a threshold amount (e.g., 5%).

In another aspect, the received QoE variation indicator received in block 920 may comprise multiple bits. The QoE variation indicator value may correspond to one or more QoE metric variations after the mobility management event. In this instance, in block 930, the cell may determine that the QoE of the UE is to be restored based on the received QoE variation indicator value. For example, of the QoE variation indicator value indicates that the UL latency has increased, then the cell may determine that the QoE metrics of the UE can be restored or otherwise improved by handing over the UE to a cell configured with higher UL density than the current serving cell.

In yet another aspect, the QoE report received in block 920 may include a QoE status indicator, which may comprise one or more bits. The QoE status indicator value may correspond to a status or statuses of one or more QoE metrics. In this instance, in block 930, the cell may determine that the QoE of the UE is to be restored based on the received QoE status indicator value. For example, of the QoE status indicator value indicates that the UL latency exceeds a threshold, e.g., exceeds 1000 ms, then the cell may determine that the QoE metrics of the UE can be restored or otherwise improved by handing over the UE to a cell configured with higher UL density than the current serving cell.

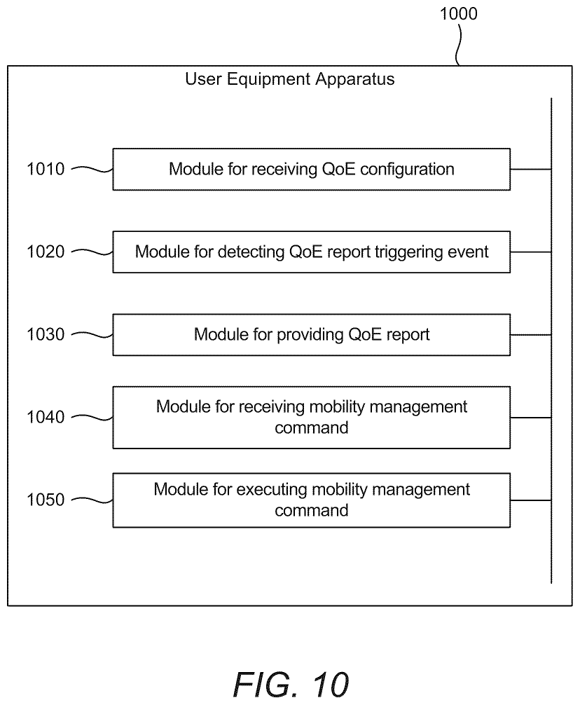

FIG. 10 illustrates an example user equipment apparatus 1000 represented as a series of interrelated functional modules connected by a common bus. Each of the modules may be implemented in hardware or as a combination of hardware and software. For example, the modules may be implemented as any combination of the modules of the apparatus 202 of FIG. 2. A module for receiving the QoE configuration 1010 may correspond at least in some aspects to a communication device (e.g., communication device 208), a processing system (e.g., processing system 232) and/or a memory component (e.g., memory component 238). A module for detecting a QoE report triggering event 1020 may correspond at least in some aspects to a communication device (e.g., communication device 208), a processing system (e.g., processing system 232), a memory component (e.g., memory component 238), and/or a measurement component (e.g., measurement component 252). A module for providing the QoE report 1030 may correspond at least in some aspects to a communication device (e.g., communication device 208), a processing system (e.g., processing system 232), and/or a memory component (e.g., memory component 238). A module for receiving a mobility management command 1040 may correspond at least in some aspects to a communication device (e.g., communication device 208), a processing system (e.g., processing system 232) and/or a memory component (e.g., memory component 238). A module for executing the mobility management command 1050 may correspond at least in some aspects to a communication device (e.g., communication device 208), a processing system (e.g., processing system 232) and/or a memory component (e.g., memory component 238).

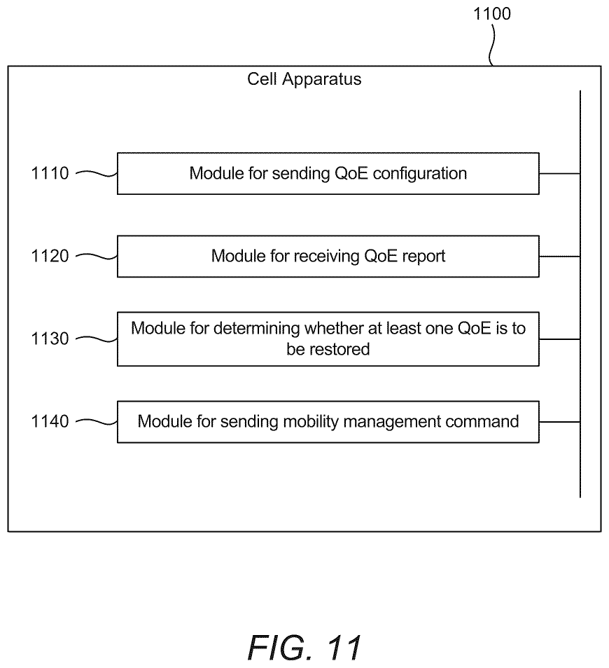

FIG. 11 illustrates an example cell apparatus 1100 represented as a series of interrelated functional modules connected by a common bus. Each of the modules may be implemented in hardware or as a combination of hardware and software. For example, the modules may be implemented as any combination of the modules of the apparatus 204 of FIG. 2. A module for sending the QoE configuration 1110 may correspond at least in some aspects to a communication device (e.g., communication device 214), a processing system (e.g., processing system 234) and/or a memory component (e.g., memory component 240). A module for receiving the QoE report 1120 may correspond at least in some aspects to a communication device (e.g., communication device 214), a processing system (e.g., processing system 234) and/or a memory component (e.g., memory component 240). A module for determining whether at least one QoE metric is to be restored 1130 may correspond at least in some aspects to a communication device (e.g., communication device 214), a processing system (e.g., processing system 234) and/or a memory component (e.g., memory component 240). A module for sending a mobility management command 1140 may correspond at least in some aspects to a communication device (e.g., communication device 214), a processing system (e.g., processing system 234) and/or a memory component (e.g., memory component 240).

The functionality of the modules of FIGS. 10 and 11 may be implemented in various ways consistent with the teachings herein. In some designs, the functionality of these modules may be implemented as one or more electrical components. In some designs, the functionality of these blocks may be implemented as a processing system including one or more processor components. In some designs, the functionality of these modules may be implemented using, for example, at least a portion of one or more integrated circuits (e.g., an ASIC). As discussed herein, an integrated circuit may include a processor, software, other related components, or some combination thereof. Thus, the functionality of different modules may be implemented, for example, as different subsets of an integrated circuit, as different subsets of a set of software modules, or a combination thereof. Also, it will be appreciated that a given subset (e.g., of an integrated circuit and/or of a set of software modules) may provide at least a portion of the functionality for more than one module.

In addition, the components and functions represented by FIGS. 10-11, as well as other components and functions described herein, may be implemented using any suitable means. Such means also may be implemented, at least in part, using corresponding structure as taught herein. For example, the components described above in conjunction with the “module for” components of FIGS. 10-11 also may correspond to similarly designated “means for” functionality. Thus, in some aspects one or more of such means may be implemented using one or more of processor components, integrated circuits, or other suitable structure as taught herein.

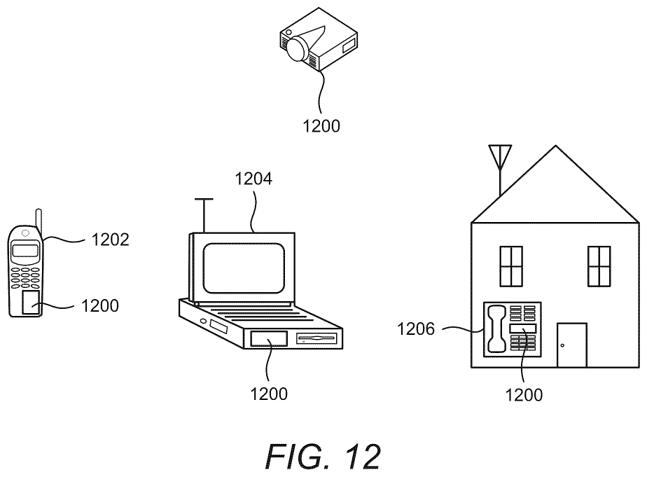

FIG. 12 illustrates various electronic devices that may be integrated with the aforementioned apparatus 202 and 1000 illustrated in FIGS. 2 and 10. For example, a mobile phone device 1202, a laptop computer device 1204, a terminal device 1206 as well as wearable devices, portable systems, that require small form factor, extreme low profile, may include an apparatus 1200 that incorporates the aforementioned devices/systems as described herein. The apparatus 1200 may also be a standalone device, such as a video sensor, a toy, a fixed sensor, an IoT (Internet of Things) device, etc. The devices 1202, 1204, 1206 illustrated in FIG. 12 are merely exemplary. Other electronic devices may also feature the apparatus 1200 including, but not limited to, a group of devices (e.g., electronic devices) that includes mobile devices, hand-held personal communication systems (PCS) units, portable data units such as personal digital assistants, global positioning system (GPS) enabled devices, navigation devices, set top boxes, music players, video players, entertainment units, fixed location data units such as meter reading equipment, communications devices, smartphones, tablet computers, computers, wearable devices, servers, routers, electronic devices implemented in automotive vehicles, or any other device that stores or retrieves data or computer instructions, or any combination thereof.

Implementation examples are described in the following numbered clauses:

Clause 1: A method of a user equipment (UE), comprising: detecting a quality of experience (QoE) report triggering event; and providing a QoE report to a network when the QoE report triggering event is detected, the QoE report comprising information related to one or more QoE metrics.

Clause 2: The method of Clause 1, wherein the one or more QoE metrics include any one or more of an uplink (UL) latency, a UL throughput, a UL error rate, a downlink (DL) latency, a DL throughput, a DL error rate, a handover (HO) frequency, a link failure frequency, a beam switch frequency, and a UE power consumption.

Clause 3: The method of any of Clauses 1-2, wherein the QoE report triggering event comprises a mobility management event in which a communication channel between the UE and the network changes.

Clause 4: The method of Clause 3, wherein the mobility management event comprises one or both of a handover (HO) of the UE from a first cell to a second cell and a beam switch from a first beam to a second beam.

Clause 5: The method of any of Clauses 3-4, wherein the QoE report comprises a QoE variation indicator comprising one bit, a value of the QoE variation indicator indicating whether at least one QoE metric has or has not improved after the mobility management event.

Clause 6: The method of any of Clauses 3-4, wherein the QoE report comprises a QoE variation indicator comprising multiple bits, a value of the QoE variation indicator corresponding to one or more variations in the one or more QoE metrics after the mobility management event, the value of the QoE variation indicator being one of one or more valid values of the QoE variation indicator, and the one or more valid values of the QoE variation indicator being mapped to the variations in the one or more QoE metrics in accordance with one or more QoE variation reporting rules.

Clause 7: The method of Clause 6, further comprising: receiving a QoE configuration from the network prior to providing the QoE report, the QoE configuration comprising at least one of the one or more QoE variation reporting rules.

Clause 8: The method of any of Clauses 6-7, wherein at least two valid values of the QoE variation indicator are mapped to different variations of a same QoE metric.

Clause 9: The method of any of Clauses 1-2, wherein the QoE report triggering event comprises a QoE status event in which a status of at least one QoE metric exceeds a threshold corresponding to the at least one QoE metric.

Clause 10: The method of Clause 9, wherein the QoE report comprises a QoE status indicator comprising one or more bits, a value of the QoE status indicator corresponding to one or more thresholds of the one or more QoE metrics, the value of the QoE status indicator being one of one or more valid values of the QoE status indicator, and the one or more valid values of the QoE status indicator being mapped to the thresholds of the one or more QoE metrics in accordance with one or more QoE status reporting rules.

Clause 11: The method of Clause 10, further comprising: receiving a QoE configuration from the network prior to providing the QoE report, the QoE configuration comprising at least one of the one or more QoE status reporting rules.

Clause 12: The method of any of Clauses 10-11, wherein at least two valid values of the QoE status indicator are mapped to different thresholds of a same QoE metric.

Clause 13: The method of any of Clauses 1-12, further comprising: receiving a mobility management command from the network subsequent to providing the QoE report; and executing the mobility management command, wherein the mobility management command is a command to perform a handover (HO) of the UE from a first cell to a second cell or a beam switch from a first beam to a second beam.

Clause 14: A user equipment comprising at least one means for performing a method of any of Clauses 1-13.

Clause 15: A user equipment comprising a processor, memory coupled with the processor, the processor and memory configured perform a method of Clauses 1-13.

Clause 16: A non-transitory computer-readable medium storing code for a user equipment comprising a processor, memory coupled with the processor, and instructions stored in the memory and executable by the processor to cause the user equipment to perform a method of any of Clauses 1-13.

Clause 17: A method of a cell of a network, comprising: receiving a quality of experience (QoE) report from a user equipment (UE), the QoE report comprising information related to one or more QoE metrics; and sending a mobility management command to the UE when it is determined, based on the QoE report, that at least one QoE metric is to be restored.

Clause 18: The method of Clause 17, wherein the one or more QoE metrics include any one or more of an uplink (UL) latency, a UL throughput, a UL error rate, a downlink (DL) latency, a DL throughput, a DL error rate, a handover (HO) frequency, a link failure frequency, a beam switch frequency, and a UE power consumption.

Clause 19: The method of any of Clauses 17-18, wherein the QoE report comprises a QoE variation indicator comprising one bit, a value of the QoE variation indicator indicating whether at least one QoE metric has or has not improved after a mobility management event.

Clause 20: The method of Clause 19, wherein the mobility management event comprises one or both of a handover (HO) of the UE from a first cell to a second cell and a beam switch from a first beam to a second beam.

Clause 21: The method of any of Clauses 17-18, wherein the QoE report comprises a QoE variation indicator comprising multiple bits, a value of the QoE variation indicator corresponding to one or more variations in the one or more QoE metrics after the mobility management event, the value of the QoE variation indicator being one of one or more valid values of the QoE variation indicator, and the one or more valid values of the QoE variation indicator being mapped to the variations in the one or more QoE metrics in accordance with one or more QoE variation reporting rules.

Clause 22: The method of Clause 21, wherein the mobility management event comprises one or both of a handover (HO) of the UE from a first cell to a second cell and a beam switch from a first beam to a second beam.

Clause 23: The method of any of Clauses 21-22, further comprising: sending a QoE configuration to the UE prior to receiving the QoE report, the QoE configuration comprising at least one of the one or more QoE variation reporting rules.

Clause 24: The method of any of Clauses 17-18, wherein the QoE report comprises a QoE status indicator comprising one or more bits, a value of the QoE status indicator corresponding to one or more thresholds of the one or more QoE metrics, the value of the QoE status indicator being one of one or more valid values of the QoE status indicator, and the one or more valid values of the QoE status indicator being mapped to the thresholds of the one or more QoE metrics in accordance with one or more QoE status reporting rules.

Clause 25: The method of Clause 24, further comprising: sending a QoE configuration to the UE prior to receiving the QoE report, the QoE configuration comprising at least one of the one or more QoE status reporting rules.

Clause 26: A cell of a network comprising at least one means for performing a method of any of Clauses 17-25.

Clause 27: A cell of a network comprising a processor, memory coupled with the processor, the processor and memory configured perform a method of Clauses 17-25.

Clause 28: A non-transitory computer-readable medium storing code for a cell of a network comprising a processor, memory coupled with the processor, and instructions stored in the memory and executable by the processor to cause the user equipment to perform a method of any of Clauses 17-25.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a DSP, an ASIC, an FPGA, or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more exemplary aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although elements of the disclosure may be described or claimed in the singular, the plural is contemplated unless limitation to the singular is explicitly stated.

What is claimed is:

1. A user equipment (UE), comprising:
a processor;
a memory; and
a transceiver,
wherein the processor, the memory, and/or the transceiver are configured to:
detect a quality of experience (QoE) report triggering event; and
provide a QoE report to a network when the QoE report triggering event is detected, the QoE report comprising information related to one or more QoE metrics.

2. The UE of claim 1, wherein the one or more QoE metrics include any one or more of an uplink (UL) latency, a UL throughput, a UL error rate, a downlink (DL) latency, a DL throughput, a DL error rate, a handover (HO) frequency, a link failure frequency, a beam switch frequency, and a UE power consumption.

3. The UE of claim 1, wherein the QoE report triggering event comprises a mobility management event in which a communication channel between the UE and the network changes.

4. The UE of claim 3, wherein the mobility management event comprises one or both of a handover (HO) of the UE from a first cell to a second cell and a beam switch from a first beam to a second beam.

5. The UE of claim 3, wherein the QoE report comprises a QoE variation indicator comprising one bit, a value of the QoE variation indicator indicating whether at least one QoE metric has or has not improved after the mobility management event.

6. The UE of claim 3, wherein the QoE report comprises a QoE variation indicator comprising multiple bits,
a value of the QoE variation indicator corresponding to one or more variations in the one or more QoE metrics after the mobility management event,
the value of the QoE variation indicator being one of one or more valid values of the QoE variation indicator, and
the one or more valid values of the QoE variation indicator being mapped to the variations in the one or more QoE metrics in accordance with one or more QoE variation reporting rules.

7. The UE of claim 6, wherein the processor, the memory, and/or the transceiver are further configured to:
receive a QoE configuration from the network prior to providing the QoE report, the QoE configuration comprising at least one of the one or more QoE variation reporting rules.

8. The UE of claim 6, wherein at least two valid values of the QoE variation indicator are mapped to different variations of a same QoE metric.

9. The UE of claim 1, wherein the QoE report triggering event comprises a QoE status event in which a status of at least one QoE metric exceeds a threshold corresponding to the at least one QoE metric.

10. The UE of claim 9, wherein the QoE report comprises a QoE status indicator comprising one or more bits,
a value of the QoE status indicator corresponding to one or more thresholds of the one or more QoE metrics,
the value of the QoE status indicator being one of one or more valid values of the QoE status indicator, and
the one or more valid values of the QoE status indicator being mapped to the thresholds of the one or more QoE metrics in accordance with one or more QoE status reporting rules.

11. The UE of claim 10, wherein the processor, the memory, and/or the transceiver are further configured to:
receive a QoE configuration from the network prior to providing the QoE report, the QoE configuration comprising at least one of the one or more QoE status reporting rules.

12. The UE of claim 10, wherein at least two valid values of the QoE status indicator are mapped to different thresholds of a same QoE metric.

13. The UE of claim 1, wherein the processor, the memory, and/or the transceiver are further configured to:
receive a mobility management command from the network subsequent to providing the QoE report; and
execute the mobility management command,
wherein the mobility management command is a command to perform a handover (HO) of the UE from a first cell to a second cell or a beam switch from a first beam to a second beam.

14. A cell of a network, comprising:
a processor;
a memory; and
a transceiver,
wherein the processor, the memory, and/or the transceiver are configured to:
receive a quality of experience (QoE) report from a user equipment (UE), the QoE report comprising information related to one or more QoE metrics; and
send a mobility management command to the UE when it is determined, based on the QoE report, that at least one QoE metric is to be restored.

15. The cell of claim 14, wherein the one or more QoE metrics include any one or more of an uplink (UL) latency, a UL throughput, a UL error rate, a downlink (DL) latency, a DL throughput, a DL error rate, a handover (HO) frequency, a link failure frequency, a beam switch frequency, and a UE power consumption.

16. The cell of claim 14, wherein the QoE report comprises a QoE variation indicator comprising one bit, a value of the QoE variation indicator indicating whether at least one QoE metric has or has not improved after a mobility management event.

17. The cell of claim 14, wherein the QoE report comprises a QoE variation indicator comprising multiple bits,
a value of the QoE variation indicator corresponding to one or more variations in the one or more QoE metrics after the mobility management event,
the value of the QoE variation indicator being one of one or more valid values of the QoE variation indicator, and
the one or more valid values of the QoE variation indicator being mapped to the variations in the one or more QoE metrics in accordance with one or more QoE variation reporting rules.

18. The cell of claim 17, wherein the processor, the memory, and/or the transceiver are further configured to:
send a QoE configuration to the UE prior to receiving the QoE report, the QoE configuration comprising at least one of the one or more QoE variation reporting rules.

19. The cell of claim 14, wherein the QoE report comprises a QoE status indicator comprising one or more bits,
a value of the QoE status indicator corresponding to one or more thresholds of the one or more QoE metrics,
the value of the QoE status indicator being one of one or more valid values of the QoE status indicator, and
the one or more valid values of the QoE status indicator being mapped to the thresholds of the one or more QoE metrics in accordance with one or more QoE status reporting rules.

20. The cell of claim 19, wherein the processor, the memory, and/or the transceiver are further configured to:
send a QoE configuration to the UE prior to receiving the QoE report, the QoE configuration comprising at least one of the one or more QoE status reporting rules.

21. A method of a user equipment (UE), the method comprising:
detecting a quality of experience (QoE) report triggering event; and
providing a QoE report to a network when the QoE report triggering event is detected, the QoE report comprising information related to one or more QoE metrics.

22. The method of claim 21, wherein the one or more QoE metrics include any one or more of an uplink (UL) latency, a UL throughput, a UL error rate, a downlink (DL) latency, a DL throughput, a DL error rate, a handover (HO) frequency, a link failure frequency, a beam switch frequency, and a UE power consumption.

23. The method of claim 21, wherein the QoE report triggering event comprises a mobility management event in which a communication channel between the UE and the network changes.

24. The method claim 23, wherein the QoE report comprises a QoE variation indicator comprising one bit, a value of the QoE variation indicator indicating whether at least one QoE metric has or has not improved after the mobility management event.

25. The method of claim 23, wherein the QoE report comprises a QoE variation indicator comprising multiple bits,
a value of the QoE variation indicator corresponding to one or more variations in the one or more QoE metrics after the mobility management event,
the value of the QoE variation indicator being one of one or more valid values of the QoE variation indicator, and
the one or more valid values of the QoE variation indicator being mapped to the variations in the one or more QoE metrics in accordance with one or more QoE variation reporting rules.

26. The method of claim 25, further comprising:
receiving a QoE configuration from the network prior to providing the QoE report, the QoE configuration comprising at least one of the one or more QoE variation reporting rules.

27. The method of claim 21,
wherein the QoE report triggering event comprises a QoE status event in which a status of at least one QoE metric exceeds a threshold corresponding to the at least one QoE metric, and
wherein the QoE report comprises a QoE status indicator comprising one or more bits,
a value of the QoE status indicator corresponding to one or more thresholds of the one or more QoE metrics,
the value of the QoE status indicator being one of one or more valid values of the QoE status indicator, and
the one or more valid values of the QoE status indicator being mapped to the thresholds of the one or more QoE metrics in accordance with one or more QoE status reporting rules.

28. The method of claim 27, further comprising:
receiving a QoE configuration from the network prior to providing the QoE report, the QoE configuration comprising at least one of the one or more QoE status reporting rules.

29. A method of a cell of a network, the method comprising:
receiving a quality of experience (QoE) report from a user equipment (UE), the QoE report comprising information related to one or more QoE metrics; and
sending a mobility management command to the UE when it is determined, based on the QoE report, that at least one QoE metric is to be restored.

30. The method of claim 29, wherein the one or more QoE metrics include any one or more of an uplink (UL) latency, a UL throughput, a UL error rate, a downlink (DL) latency, a DL throughput, a DL error rate, a handover (HO) frequency, a link failure frequency, a beam switch frequency, and a UE power consumption.
